(19) United States
(12) Patent Application Publication
(10) Pub. No.: US 2024/0065229 A1
(43) Pub. Date: Feb. 29, 2024

(54) RETRACTABLE DOG LEASH WITH GRAVITY LOCKING MECHANISM

(71) Applicant: David Dekarske, Lancaster, SC (US)

(72) Inventor: David Dekarske, Lancaster, SC (US)

(21) Appl. No.: 17/898,717

(22) Filed: Aug. 30, 2022

(51) Int. Cl. A01K 27/00

(52) U.S. Cl. CPC A01K 27/004; A01K 27/005

(57) ABSTRACT

A retractable dog leash. The dog leash includes a cylindrical housing having a housing front cover and housing rear cover. A spring-loaded retraction device is positioned in the housing adjacent to the rear cover and a linear compression spring is positioned between the spring-loaded retraction device and the front cover. The spring-loaded retraction device includes a gravity locking device for locking the dog leash. A cord is connected to the spring-loaded retraction device and a dog collar connection device is connected to the cord.

The present invention relates to dog walking devices, and in particular, to dog walking devices with a retractable leash.

### BACKGROUND OF THE INVENTION

Domesticated dogs are found throughout the world. They offer companionship, protection and love for their families. Additionally, dogs can be trained to serve law enforcement, search and rescue organizations and the military. They work on farms and on ranches.

It is important that dog owners provide optimum care for their dogs. Dogs need to be properly fed, trained and exercised. Often it is very difficult to allow a dog to run free off-leash. It is very common for areas of society to require dogs to be on leashes while being walked. In many cases strict leash laws are enforced.

There are currently a variety of leashes available in the prior art available. Some of these leashes show the utilization of a retractable leash. However, some of these devices are cumbersome to operate with flimsy parts that can become fouled or break.

What is needed is a better retractable dog leash that is sturdy and easy to operate.

### SUMMARY OF THE INVENTION

The present invention provides a retractable dog leash. The dog leash includes a cylindrical housing having a housing front cover and housing rear cover. A spring-loaded retraction device is positioned in the housing adjacent to the rear cover and a linear compression spring is positioned between the spring-loaded retraction device and the front cover. The spring-loaded retraction device includes a gravity locking device for locking the dog leash. A cord is connected to the spring-loaded retraction device and a dog collar connection device is connected to the cord.

### BRIEF DESCRIPTION OF THE DRAWINGS

FIG. 1 shows a preferred retractable dog leash.

FIG. 2 shows a cutaway view of a preferred retractable dog leash.

FIG. 3 shows a cross sectional view of a preferred cylinder.

FIG. 4 shows a cross sectional view of a preferred spring-loaded retraction device.

FIG. 4B shows a perspective view of a preferred spring-loaded retraction device.

FIG. 5 shows the spring-loaded retraction device within the cylinder.

FIG. 6 shows a perspective view of a preferred magnetic-locking attachment clip.

FIG. 7 shows a side view of a preferred magnetic-locking attachment clip.

FIGS. 8-15 show the utilization of the magnetic-locking attachment clip.

FIG. 16 shows the dog leash connected to a dog collar ring.

FIG. 17 shows internal components of the dog leash.

FIGS. 18-20 show the components of a preferred spring-loaded retraction device.

FIGS. 21A-22C show the operation of the spring-loaded retraction device.

FIG. 23 shows the compression of the linear spring for shock absorption.

### DETAILED DESCRIPTION OF THE PREFERRED EMBODIMENTS

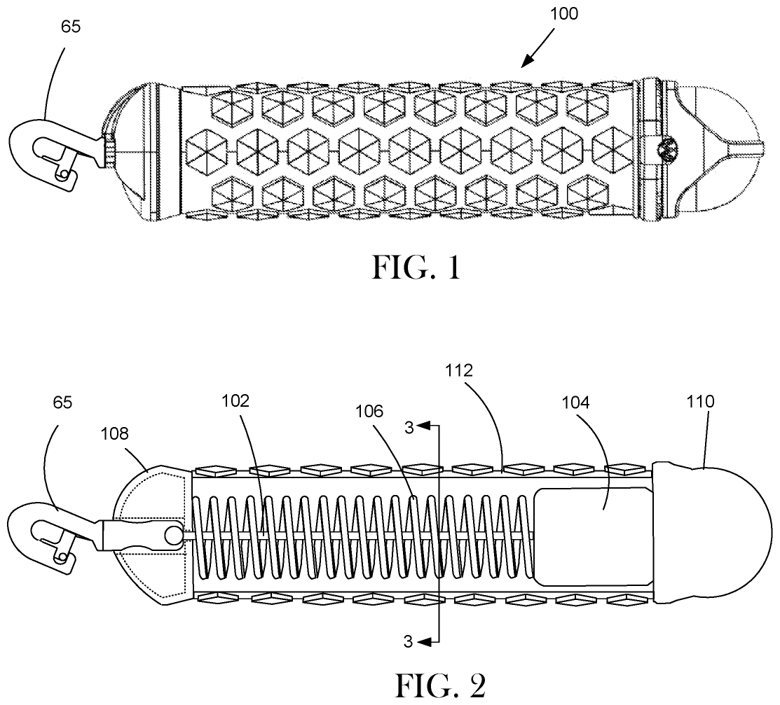

FIG. 1 shows preferred retractable dog leash 100. Retractable dog leash 100 includes magnetic-locking attachment clip 65.

FIG. 2 shows a cutaway view of dog leash 100. Clip 65 is connected to cord 102. Cord 102 is connected to spring loaded retraction device 104. Linear spring 106 is positioned between spring loaded retraction device 104 and front cover 180 and is biased to provide a compressive force against spring loaded retraction device 104. Rear cover 110 is connected to the rear of cylinder 112 and front cover 108 is connected to the front of cylinder 112.

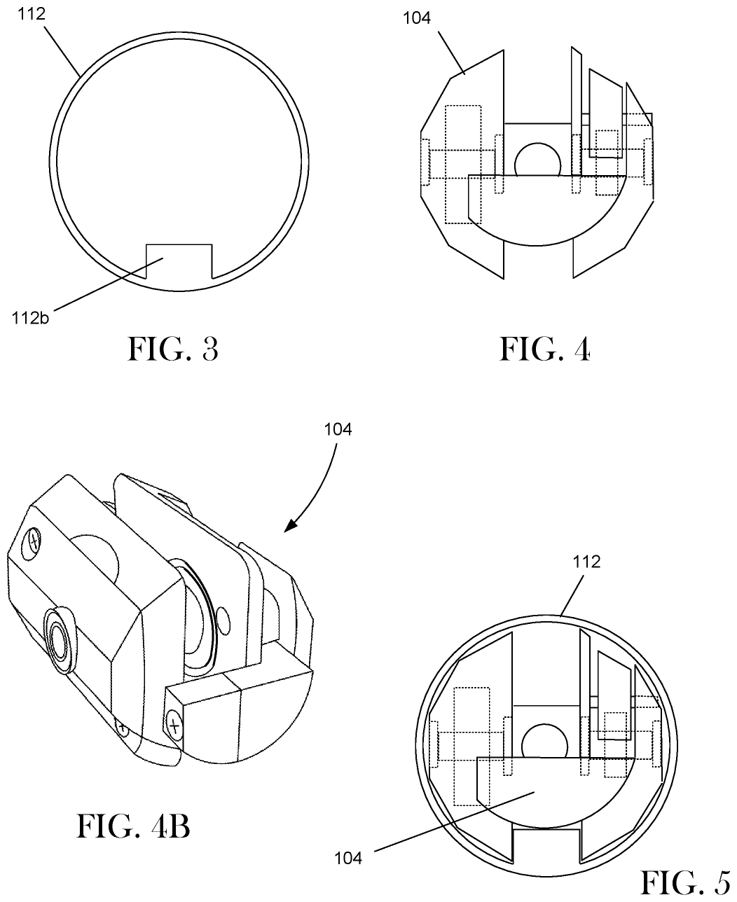

FIG. 3 shows a cutaway rear view of cylinder 112. It should be noted that in the preferred embodiment shown, cylinder 112 has a circular cross section with alignment track 112b. As shown in FIGS. 4 and 4B, spring-loaded retraction device 104 has the general shape of a twelve-sided polygon (FIG. 4). Spring-loaded retraction device is faceted to reduce the linear drag on its sidewalls while still allowing the retraction device 104 to slide easily between along track 112b internal to cylinder 112. For example, FIG. 5 shows spring-loaded retraction device 104 placed inside cylinder 112. As shown, spring-loaded retraction device 104 is prevented from moving rotationally relative to cylinder 112 due to its positioning on alignment track 112b. However, spring loaded retraction device 104 is free to slide linearly easily on alignment track 112b within cylinder 112.

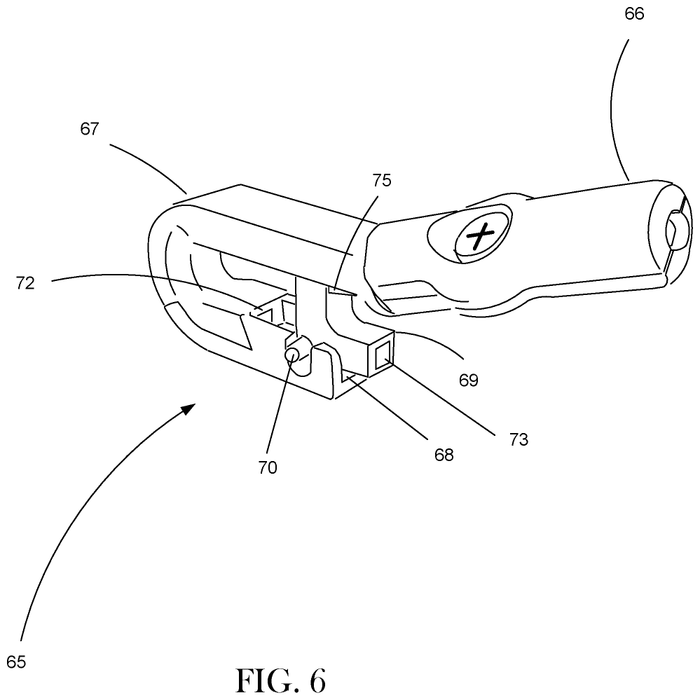

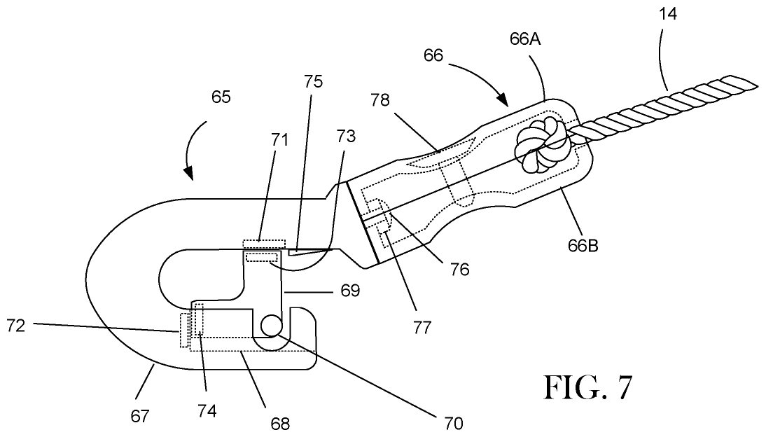

FIG. 6 shows a perspective view and FIG. 7 shows a side view of magnetic-locking attachment clip 65. Attachment clip 65 includes cord cover section 66 for connection to cord 14 (FIG. 1). Clip section 67 is pivotally connected to cord cover section 66. Clip section 67 further includes magnets 71 and 72 arranged as shown. Clip section 67 also includes cutout section 68 that allows for the pivotal connection of L-shaped rocker 69. L-shaped rocker 69 includes pivot axis 70. Magnets 73 and 74 are attached to L-shaped rocker 69 and interact with magnets 71 and 72 of clip section 67. Ramp 75 prevents unwanted rotation of L-shaped rocker 69.

Pivot screw 76 is threaded into clip section 67. Cord cover section 66 pivots about the axis formed by pivot screw 76. Rubber washer 77 provides support for cord cover section 66. Upper cover 66A and lower cover 66B are joined together tightly by utilization of connection screw 78.

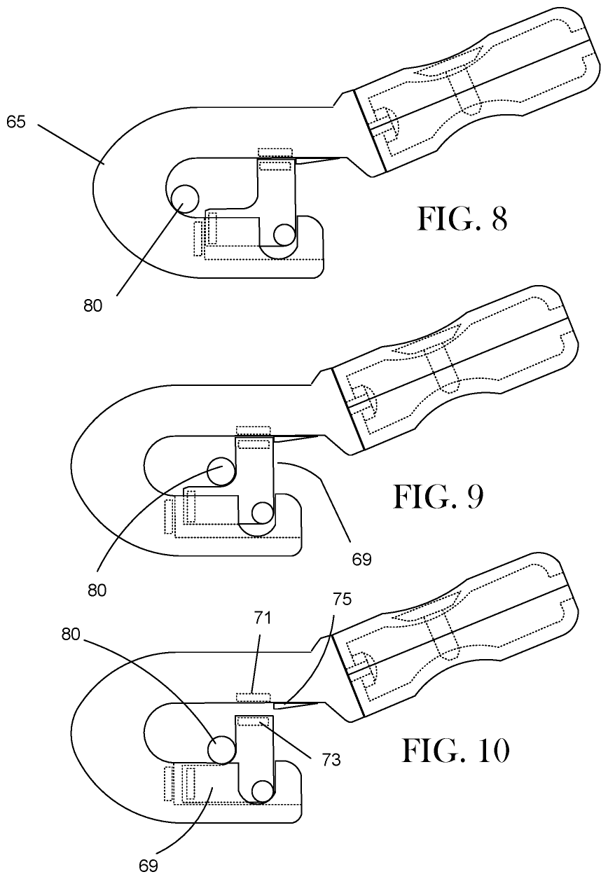

FIGS. 8-15 depict the utilization of magnetic-locking attachment clip 65.

FIG. 8 shows clip 65 connected to a dog's collar ring 80 (see also FIG. 1).

In FIG. 9, the user has decided that he wants to remove clip 65 from collar ring 80 and has moved collar ring 80 towards L-shaped rocker 69.

In FIG. 10 the user has used ring 80 to push down on L-shaped rocker 69 to overcome the magnetic attraction force between magnets 71 and 73 and to also clear ramp 75.

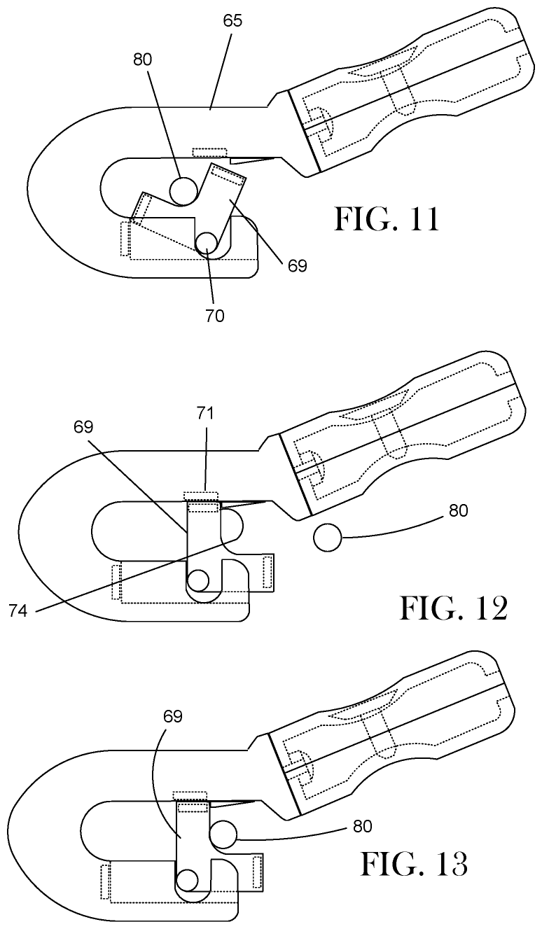

In FIG. 11 the user is continuing to pull ring 80 away from clip 65. L-shaped rocker 69 is rotating about pivot axis 70.

In FIG. 12 the user has removed ring 80 from clip 65. L-shaped rocker has completed rotated to the position shown and is held steady in place by the magnetic attraction between magnets 74 and 71.

In FIG. 13 the user has decided to reattach clip 65 to ring 80 and has moved ring 80 towards L-shaped rocker 69.

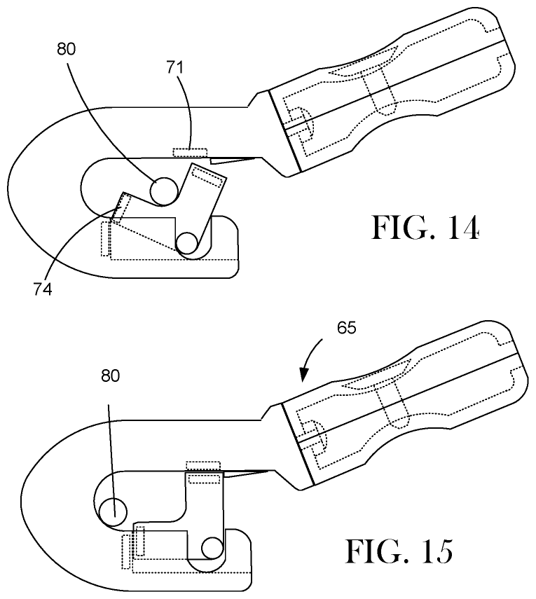

In FIG. 14 the user has push ring 80 further into clip 65 and has overcome the magnetic attraction force between magnets 71 and 74.

In FIG. 15 the user has completed connecting clip 65 to ring 80 so that clip 65 is in the position shown earlier in FIGS. 8 and 1.

### Utilization of a Preferred Embodiment

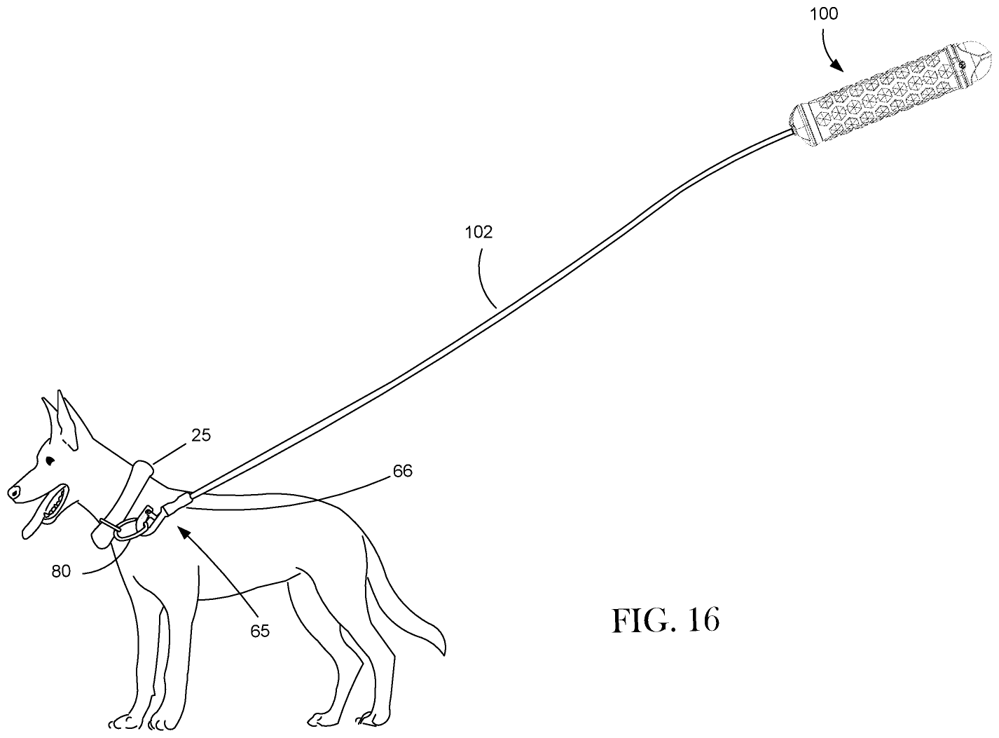

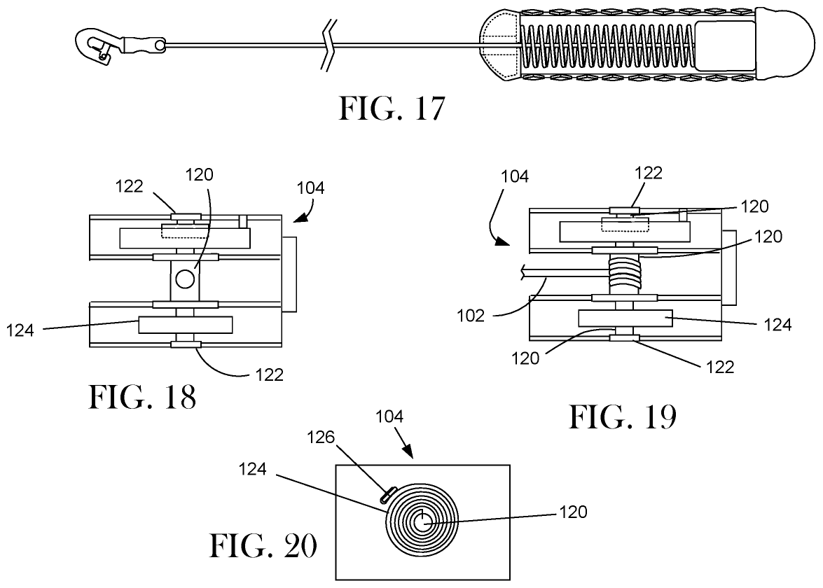

In FIG. 16 the user has connected clip 65 to collar ring 80. Cord 102 is connected to clip 65 at one end and is connected to and wound around axle 120 of spring-loaded retraction device 104 (FIGS. 17-18). Axle 120 extends through spring-loaded retraction device 104 and rides on bearings 122 as shown. Spring-loaded retraction device 104 includes coil spring 124. Coil spring 124 is connected between axle 120 and connection tab 126. Connection tab 126 is rigidly connected to spring-loaded retraction device 104. Coil spring 124 is biased to wind clip 65 inward to cylinder 112 to the position shown in FIGS. 1 and 2.

In FIG. 16 the user has initially allowed the dog to walk and pull on cord 102 to overcome the retraction force of coil spring 124. The dog is shown at a distance that is comfortable for the user and the dog. The user has then decided that he does not want the dog to have a longer leash. Therefore, the user has decided to lock spring-loaded retraction device 104 so that no further cord 102 will be played out.

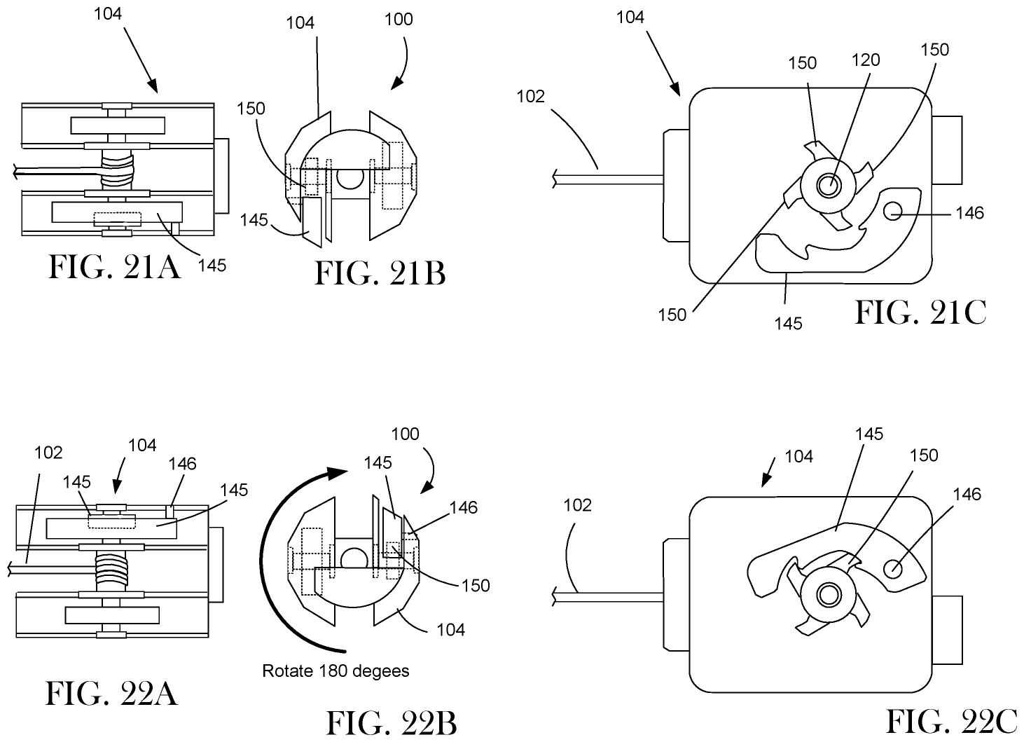

To lock spring-loaded retraction device 104, the user rotates dog leash 100 180 degrees. For example, FIG. 21A-21C show a top view, rear view and side view of spring-loaded retraction device 104. Spring-loaded retraction device 104 includes pivotally attached gravity locking bar 145. Gravity locking bar 145 is pivotally connected via pivot pin 146 to spring-loaded retraction device 104.

In FIGS. 21A-21C, the user has decided to keep dog leash 100 unlocked. Therefore, the user is holding dog leash 100 in the position shown so that gravity locking bar 145 dangles freely below locking blades 150. Locking blades 150 are rigidly connected to axle 120. Axle 120 rotates counterclockwise (FIG. 21C) to play out cord 102 to allow the leash to expand as desired. In the position shown in FIGS. 21A-21C, there is no locking of axle 120 and cord 102 is free to expand or contract

In FIGS. 22A-22C, the user has decided to lock dog leash 100 and that he does not want the distance of cord 102 to play out any further. Therefore, the user has rotated dog leash 100 180 degrees. Likewise, spring-loaded retraction device 104 is rotated 180 degrees (FIG. 22B). Consequently, the force of gravity causes gravity locking bar 145 to rotate counterclockwise about pivot pin 146 and thereby meshing with locking blades 150 to stop the clockwise (FIG. 22C) rotation of axle 120. Therefore, cord 102 is prevented from further pay out and dog leash 100 is locked.

It should be noted that while clockwise rotation of axle 120 has been stopped in FIG. 22C, counterclockwise motion is permitted thereby allowing coil spring 124 to retract cord 102 as the distance between the user and the dog decreases. In other words, the interface of gravity locking bar 145 in relation to locking blades 150 is such that while the device is locked, the radial force of coil spring 124 can overcome the surface friction between the interface points of locking bar 145 and locking blades 150. Therefore, gravity locking bar 145 can rotate radially out of its locking position to allow counterclockwise rotation of locking blades 150 to permit the retraction of cord 102 when there is a reduced tension on the cord. Conversely, when the cord tension of cord 102 increases beyond the strength of coil spring 124, locking bar 145 once again meshes with locking blades 150 to stop the clockwise (FIG. 22C) rotation of axle 120.

To unlock dog leash 100 once again the user only needs to rotate dog leash 100 180 degrees to put it in the position shown in FIGS. 21A-21C.

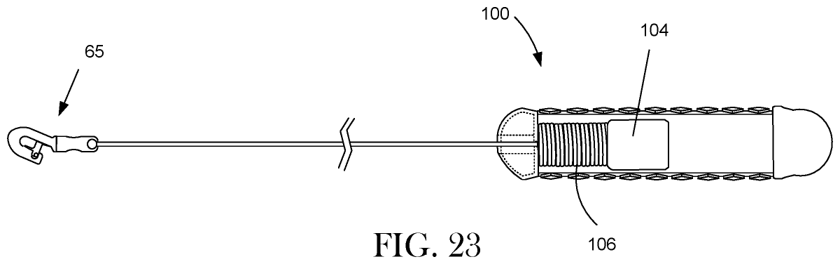

In FIG. 23 the user has locked leash 100. However, the dog has pulled on leash 100 causing attachment clip 65 to move further to the left. Spring-loaded retraction device 104 has slid linearly within cylinder 112. This causes linear compression spring 106 to compress thereby providing shock absorption to the user and the dog for comfort and safety.

While the present invention has been described in terms of preferred embodiments, the reader should consider these described embodiments only as particular embodiments. Many other embodiments are possible. Therefore, the reader should determine the scope of the present invention by the claims and their legal equivalents.

What is claimed is:

1. A retractable dog leash, comprising:
A. a cylindrical housing,
B. a housing front cover,
C. a housing rear cover,
D. a spring-loaded retraction device positioned adjacent to said housing rear cover, said spring-loaded retraction device comprising a gravity locking device,
E. a linear compression spring positioned between said housing front cover and said spring-loaded retraction device,
F. a cord connected to said spring-loaded retraction device, and
G. a dog collar connection device connected to said cord.

2. The retractable dog leash as in claim 1, wherein said cylindrical housing comprises a circular cross section and an alignment track to prevent relative rotational motion but allow relative linear motion between said cylindrical housing and said spring-loaded retraction device.

3. The retractable dog leash as in claim 2, wherein said polygon is a twelve-sided polygon.

4. The retractable dog leash as in claim 1, wherein said spring-loaded retraction device comprises:
A. spring-loaded retraction device housing,
B. an axle rotatably connected to said housing, said cord connected to said axle,
C. a retractable coil spring connected between said axle and said housing, said coil spring biased to wind in said cord and said dog collar connection device, wherein said gravity locking device comprises:
i. locking blades rigidly connected to said axle, and
ii. a locking bar pivotally connected to said housing, wherein by rotating said retractable dog leash gravitational force causes said locking bar to either engage said locking blades to lock said dog leash or gravity causes said locking bar to become disengaged with said locking blades to unlock said dog leash.

5. The retractable dog leash as in claim 1, wherein said dog collar connection device is a magnetic-locking attachment clip, said magnetic-locking attachment clip comprising:
A. a cord cover section, and
B. a clip section rotatably connected to said cord cover section.

6. The retractable dog leash as in claim 5, wherein said clip section comprises:
A. an L-shaped rocker pivotally connected to said clip section, said L-shaped rocker comprising a pivot axle and at least one rocker magnet,
B. at least one clip magnet connected to said clip section and a pivot axle receiving area embedded within said clip section,
C. wherein a dog collar ring is attached and removed from said clip section by pressing against said L-shaped rocker to overcome magnetic attraction force between said at least one clip magnet and said at least one rocker magnet.
